(19) United States
(12) Patent Application Publication
(10) Pub. No.: US 2014/0338505 A1
(43) Pub. Date: Nov. 20, 2014

(54) DRIVING-IN DEVICE

(71) Applicant: Hilti Aktiengesellschaft, Schaan (LI)

(72) Inventors: Thomas Foser, Balzers (LI); Oliver Prinz, Lindau (DE)

(21) Appl. No.: 14/367,448

(22) PCT Filed: Nov. 28, 2012
(86) PCT No.: PCT/EP2012/073782

§ 371 Date: Jun. 20, 2014

(30) Foreign Application Priority Data
Dec. 22, 2011 (DE) 10 2011 089 521.3

(51) Int. Cl. B25B 23/04

(52) U.S. Cl. CPC B25B 23/04; B25B 23/045
USPC 81/434; 81/57.37

(57) ABSTRACT

A device is disclosed for driving fastening elements into a substrate, comprising a receptacle for a fastening element, having a driving-in element which drives a fastening element in the receptacle into the substrate, a transport element which can be brought into engagement with a fastening element or a strip comprising a fastening element in order to transport the fastening element in a transporting direction into the receptacle, and a catch which has a blocking position and an enabling position, wherein the catch blocks a transporting movement of the fastening element in the blocking position and enables the transporting movement in the enabling position.

The invention concerns a device for driving fastening elements into a substrate.

Such devices usually comprise a screwdriver bit, which drives the fastening element into a substrate. In order to position the fastening elements in front of the screwdriver bit, there are known transport gears that in each case engage between two fastening elements of a fastening element strip in order to transport a fastening element into a receptacle in front of the screwdriver bit. The force for this is supplied by the user of the device, for example, by pressing the device against a substrate. In addition, during the driving-in operation the fastening element is supplied with a force transverse to the fastening direction.

It is a task of the invention to make available a driving-in device with a simple transport mechanism, in which, if applicable, the forces that arise are reduced and in particular are avoided.

The task is solved by a device for driving fastening elements into a substrate having a receptacle for a fastening element and a driving-in element, which drives a fastening element in the receptacle into the substrate. Further, the device comprises a transport element, which can be brought into engagement with a fastening element or a strip comprising a fastening element by means of a first spring force, in order to transport the fastening element in a transport device into the receptacle, and a retaining element, which can be brought into engagement with a fastening element or a strip comprising a fastening element by means of a second spring force, in order to block a movement of the fastening element against the transport direction.

A preferred embodiment is characterized in that the device has a transport spring, which supplies the transport element with the first spring force against the fastening element or the strip. Preferably, the transport element is formed by the transport spring.

A preferred embodiment is characterized in that the device has a retaining spring, which supplies the retaining element with the second spring force against the fastening element or the strip. Preferably, the retaining element is formed by the retaining spring.

A preferred embodiment is characterized in that the transport element has one or more transport projections for engagement in corresponding recesses on the strip and/or for engagement between two fastening elements. The recesses are preferably each disposed between two fastening elements. According to another embodiment the recesses are each disposed at the level of one fastening element, especially its lengthwise axis. Preferably, the transport element is mounted so that it can pivot about a first pivot axis.

An especially preferred embodiment is characterized in that the transport projection has a first ramp on the side of it that is turned away from the receptacle, which produces a movement of the transport element transverse to the transport direction when there is a force of the fastening element or the strip acting on the transport element in the transport direction.

A preferred embodiment is characterized in that the retaining element has one or more retaining projections for engagement in corresponding recesses on the strip or for engagement between two fastening elements. Preferably the retaining element is mounted so that it can pivot about a second pivot axis.

An especially preferred embodiment is characterized in that the retaining projection has a second ramp on the side of it that is turned away from the receptacle, which produces a movement of the retaining element transverse to the transport direction when there is a force of the fastening element or the strip acting on the transport element in the transport direction.

A preferred embodiment is characterized in that the transport element is disposed so that it can be moved in the transport direction.

A preferred embodiment is characterized in that the retaining element is disposed so that it cannot be moved in the transport direction.

A preferred embodiment is characterized in that the device comprises a pressure sensor, which actuates the transport element for transport of the fastening element in the transport device into the receptacle when the device is pressed against a substrate or when a driving-in operation has been completed.

Preferred embodiment examples are explained in more detail with reference to the drawings. Here:

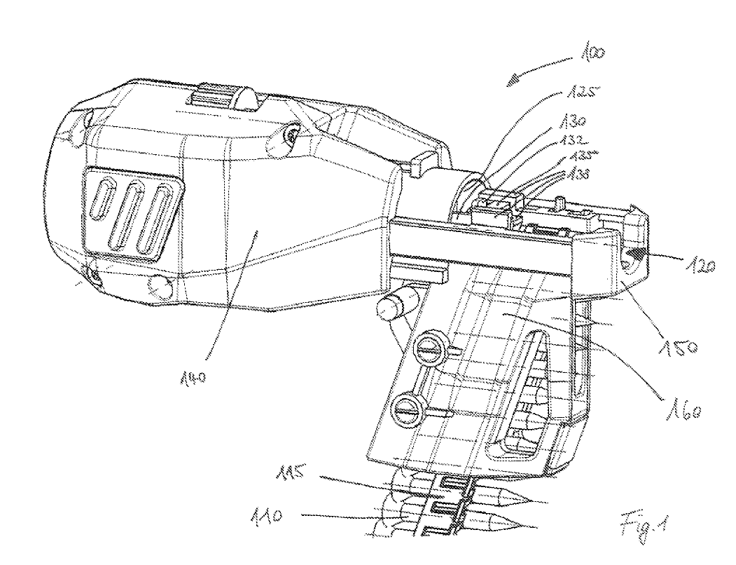

FIG. 1 shows a driving-in device,

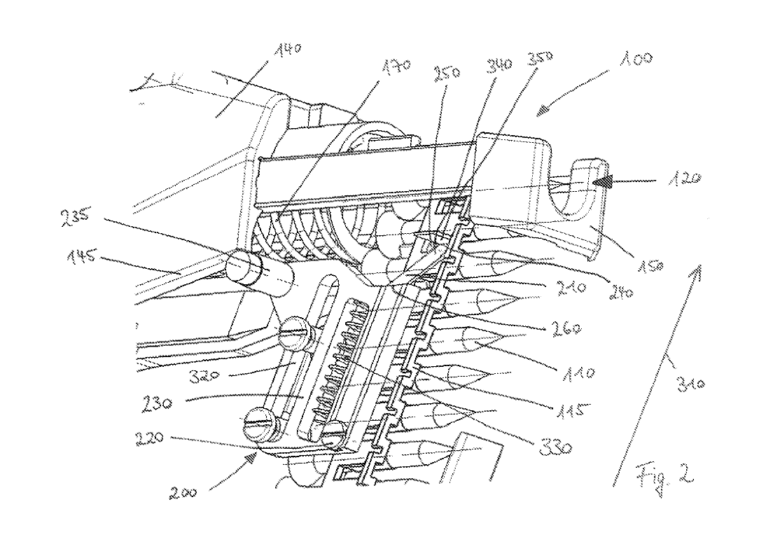

FIG. 2 shows a transport mechanism of a driving-in device, and

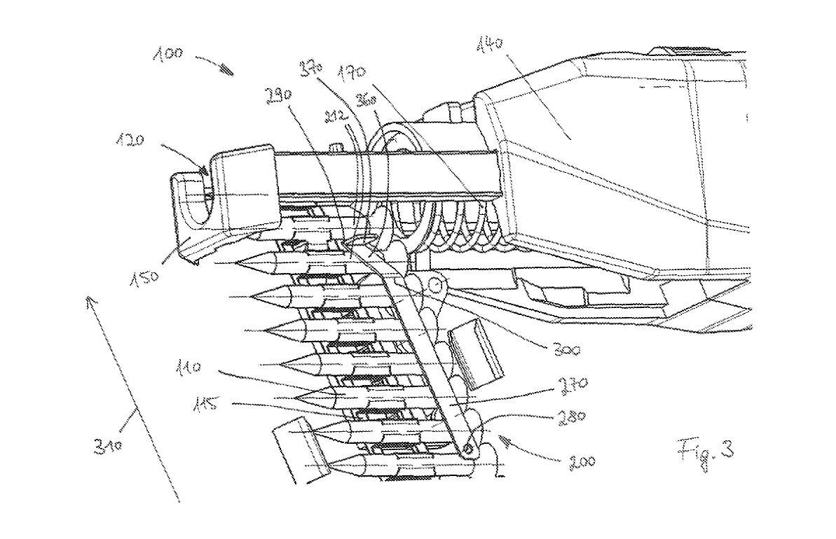

FIG. 3 shows a transport mechanism.

FIG. 1 shows a driving-in device 100 for fastening elements 110, which are preferably held by a strip 115, the driving-in device being made as a magazine attachment. The driving-in device 100 has a receptacle 120 for one of the fastening elements 110 in each case and a passage 125 for a driving-in element, made, for example, as a screwdriver, which is not shown, which drives a fastening element 110, which was positioned beforehand in the receptacle 120, into a substrate, which is not shown. Further, the driving-in device 100 has a housing 140, which is separably attached to a drive device, which is not shown, such as a battery-powered screwdriver with an electric motor, which preferably holds the driving-in element, in order to drive the driving-in element 130, in particular by rotation. The fastening elements 110 are made as screws in this embodiment example. In other examples, which are not shown, the fastening elements are designed as screw anchors, bolts, threaded bolts, nails, rivets, or the like.

The driving-in device 100 additionally comprises a pressure sensor 150, which actuates a transport mechanism, which is covered by a magazine cover 160, for transport of a fastening element 110 into the receptacle 120 when the driving-in device 100 is pressed against the substrate and/or when a driving-in operation has been completed. When pressed against a substrate. the pressure sensor 150 and, with it, the transport mechanism are moved toward the housing 140 against a pressure spring, which is covered by the housing 140, and are correspondingly moved away from the housing 140 by the pressure spring when the driving-in device 100 is lifted from the substrate.

The driving-in device 100 additionally comprises a stop 135 adjacent to the receptacle 120, which prevents transport of the fastening elements 110 past the receptacle 120. As long as the fastening elements 110 are isolated from the strip 115 in the receptacle 120, the strip 115 can be moved upward out of the driving-in device 100 past the stop 135 in FIG. 1. In order also to be able to remove the strip 115 with unused fastening elements 110 from the driving-in device 100, the stop 135 can be made slideable over an actuation projection 132 against a stop spring, which is not shown, preferably against the pressure spring. For this purpose the stop 135 has guide rails 130, which are guided in guides 138 of the driving-in device 100, and can be moved to the left in FIG. 1 out of the path of the fastening elements 110.

FIGS. 2 and 3 show different views of the driving-in device 100, where in each case the magazine cover has been removed for better representation, so that the pressure spring 170 and the transport mechanism 200 are each partially visible. In each case the driving-device 100 is not pressed against the substrate but is in a ready to use state. The transport mechanism 200 comprises a transport element 210 which is made as a bent leaf spring and thus forms a transport spring. The transport element 210 is affixed to a transport carriage 230 by a screw 220 and is pressed against the strip 115 by its spring force so that the transport element 210 engages the strip 115. The transport element 210 has a transport projection 240, which is formed by a corresponding bend of the leaf spring and engages in the corresponding recesses 250 in the strip 115. The transport element 210 with the transport projection 240 is mounted so that it can pivot about a first pivot axis 260. The recesses 250 are designed as gaps. In other embodiment examples, which are not shown, the recesses are made as depressions.

Further, the transport mechanism 200 comprises a retaining element 270, which is made as a bent leaf spring and thus forms a retaining spring. The retaining element 270 is affixed to the magazine cover, which is not shown in FIG. 3, by means of a screw 280 and presses against the strip 115 with the fastening elements 110 by means of its spring force, so that the retaining element 270 engages the strip 115. The retaining element has a retaining projection 290, which is formed by a corresponding bend of the leaf spring and engages between the shafts 212 of two fastening elements 110 of the strip 115. The retaining element 270 is mounted pivotably with the retaining projection 290 about a second pivot axis 300.

If the driving-in device 100 is pressed against the substrate starting from the position shown in FIG. 2 for a driving-in operation, the pressure sensor 150 together with the transport mechanism 200 are moved against the pressure spring 170 to the housing 140, via which the transport mechanism 200 is actuated a first time. A guide pin 235 solidly connected to the transport carriage 230, and thus the transport carriage 230 itself is moved over a guide edge 145 of the housing 140, which is inclined in a pressing direction against the transport direction 310, and an advancing spring 330 is tensioned. For this the transport carriage 230 with the transport element 210 is arranged by means of a guide 320 so that it can slide in the transport direction 310.

As described below, the strip 115 with the fastening elements 110 is prevented by the retaining element 270 from being moved opposite the fastening direction 310, so that during the movement of the transport carriage 230 a force acts from the strip 115 on the transport projection 240 in the transport direction. The transport projection 240 has a first ramp 340 on its side turned away from the receptacle 120, which produces a movement of the transport element 210 transverse to the transport direction 310 because of the said force. During the movement of the transport carriage 230, the transport projection 240 slides out of the recess 250 and into the next recess 250.

If the driving-in device 100 is again lifted from the substrate after the driving-in operation, the pressure sensor 150 and, with it, the transport mechanism 200 are moved away from the housing 140 by means of the pressure spring 170, via which the transport mechanism 200 is actuated a second time. Because of the tensioned advancing spring 330 the transport carriage 230 is moved in the transport direction 310, and the guide pin 235 is released from the guide edge 145 during the lifting movement again in FIG. 2 as above. The transport projection 240 has a carrying surface 350 on the side of it that is turned toward the receptacle 120, the surface preferably being oriented perpendicular to the transport direction 310. The carrying surface 350 is formed by a bent partial piece, in particular an end piece, of the transport element 210. In an embodiment example that is not shown the carrying surface is formed by a face side of the transport element, preferably the transport projection 240. During the movement of the transport carriage 230, the transport projection 240 carries the strip in the transport direction 310 and in this way transports a fastening element 110 into the receptacle 120 and as applicable against the stop 135, which is hidden in FIG. 2. The fastening element 110 is then supported, in particular held, in the desired position in the receptacle 120 by the transport element 210 and/or the retaining element 270, advantageously it is supported, in particular held, only by the transport element 210 and/or the retaining element 270.

During the transport a force acts in the transport direction from the strip 115 via the fastening elements 110 on the retaining projection 290. The retaining projection 290 has a second ramp 360 on the side of it that is turned away from the recess 120, the ramp producing a movement of the retaining element 270 transverse to the transport direction 310 because of said force. During the movement of the strip 115, the fastening elements 110 slide by the retaining projection 290, which is swiveled out of an intermediate space between two fastening elements 110 and into the next intermediate space between two fastening elements.

The retaining projection 290 has a blocking surface 370 on the side of it that is turned toward the receptacle 120, the surface preferably being oriented perpendicular to the transport direction 310. The blocking surface 370 is formed by a bent partial piece, especially an end piece, of the retaining element 270. In an embodiment example that is not shown, the blocking surface is formed by a face side of the retaining element, preferably the retaining projection. During the movement of the transport carriage 230 against the transport direction 310, the retaining projection 290 with the blocking surface 370 blocks the strip and thus prevents an undesired carrying of the strip 115 with the transport carriage 230 against the transport direction. For this purpose the retaining element 270 is disposed so that it cannot move in the transport direction.

Thus summarizing, when the driving-in device 100 is pressed, a transport of the fastening elements 110 is prepared by the transport carriage 230 and thus the transport element 210 being moved against the transport direction, while the strip 115 remains in its position. When the driving-in device 110 is lifted after the driving-in operation, a fastening element 110 is transported into the receptacle 120 by the transport carriage 230 moving the strip in the transport direction over the carrying surface 350 of the transport element 210, while the retaining element 270 is swiveled from the path of travel of the fastening elements 110. Thus, the driving-in device 110 has already been made ready again after being lifted from the substrate and the next driving-in operation can already be begun during the next pressing against a substrate without a fastening element having to be brought into position first.

In case of the driving-in device that is shown, the transport element engages in recesses of a fastening element strip, and the retaining element engages in the intermediate space between two fastening elements from the opposite side. In embodiment examples that are not shown, the retaining element engages in recesses of a fastening element strip, and the transport element engages in the intermediate space between two fastening elements from the same or opposite side. In other embodiment examples that are not shown, both the transport element and the retaining element engage in recesses of a fastening element strip. In other embodiment examples that are not shown, both the transport element as well as the retaining element engage in intermediate spaces between two fastening elements each. An arrangement of the retaining element on the same side as the transport elements is basically just as possible as an arrangement on the opposite side.

This invention was presented based on the example of a driving-in device for fastening elements. However, it is also pointed out that the device in accordance with the invention is also suitable for other application purposes.

1. A device for driving fastening elements into a substrate, comprising a receptacle for a fastening element, having a passage for a driving-in element, which drives the fastening element from the receptacle into the substrate; a transport element, which can be brought into engagement with the fastening element or a strip comprising the fastening element by a first spring force to transport the fastening element in a transport direction into the receptacle; and a retaining element, which can be brought into engagement with the fastening element or the strip comprising the fastening element by a second spring force, in order to block a movement of the fastening element against the transport direction.

2. The device as in claim 1, where the device comprises a transport spring, which supplies the transport element with the first spring force against the fastening element or the strip.

3. The device as in claim 2, where the transport element is formed by the transport spring.

4. The device as in claim 1, where the device comprises a retaining spring, which supplies the retaining element with the second spring force against the fastening element or the strip.

5. The device as in claim 4, where the retaining element is formed by the retaining spring.

6. The device as in claim 1, where the transport element has one or more transport projections for engagement in corresponding recesses on the strip or for engagement between two fastening elements.

7. The device as in claim 6, where the transport projection has, on a side of the transport projection that is turned away from the receptacle, a first ramp, which, if there is a force of the fastening element or the strip acting on the transport element in the transport direction, produces a movement of the transport element transverse to the transport direction.

8. The device as in claim 1, where the transport element is mounted so that it can pivot about a first pivot axis.

9. The device as in claim 1, where the retaining element has one or more retaining projections for engagement into corresponding recesses on the strip or for engagement between two fastening elements.

10. The device as in claim 9, where the retaining projection has, on a side of the retaining projection that is turned away from the receptacle, a second ramp, which, if there is a force of the fastening element or the strip acting on the transport element in the transport direction, produces a movement of the retaining element transverse to the transport direction.

11. The device as in claim 1, where the retaining element is mounted so that it can pivot about a second pivot axis.

12. The device as in claim 1, where the transport element is disposed so that it can be moved in the transport direction.

13. The device as in claim 1, where the retaining element is disposed so that it cannot move in the transport direction.

14. The device as in claim 1, comprising a pressure sensor, which actuates the transport element for transport of the fastening element in the transport direction into the receptacle when the device is pressed against a substrate and/or when a driving-in operation has been completed.

15. The device as in claim 2, where the device comprises a retaining spring, which supplies the retaining element with the second spring force against the fastening element or the strip.

16. The device as in claim 3, where the device comprises a retaining spring, which supplies the retaining element with the second spring force against the fastening element or the strip.

17. The device as in claim 2, where the transport element has one or more transport projections for engagement in corresponding recesses on the strip or for engagement between two fastening elements.

18. The device as in claim 3, where the transport element has one or more transport projections for engagement in corresponding recesses on the strip or for engagement between two fastening elements.

19. The device as in claim 4, where the transport element has one or more transport projections for engagement in corresponding recesses on the strip or for engagement between two fastening elements.

20. The device as in claim 5, where the transport element has one or more transport projections for engagement in corresponding recesses on the strip or for engagement between two fastening elements.
